(19) United States
(12) Patent Application Publication
(10) Pub. No.: US 2016/0185219 A1
(43) Pub. Date: Jun. 30, 2016

(54) VEHICLE-MOUNTED DISPLAY CONTROL DEVICE

(71) Applicant: MITSUBISHI ELECTRIC CORPORATION, Tokyo (JP)

(72) Inventors: Reiko SAKATA, Tokyo (JP); Takuji MORIMOTO, Tokyo (JP)

(73) Assignee: MITSUBISHI ELECTRIC CORPORATION, Tokyo (JP)

(21) Appl. No.: 14/909,699

(22) PCT Filed: Aug. 19, 2013
(86) PCT No.: PCT/JP2013/072081

§ 371 Date: Feb. 2, 2016

(51) Int. Cl. B60K 35/00; G08G 1/16; G01C 21/36

(52) U.S. Cl. CPC B60K 35/00; G01C 21/3697; G08G 1/16; G01C 21/36; B60K 2350/1096; B60K 2350/352

(57) ABSTRACT

Provided is a vehicle-mounted display control device including: a vehicle state acquiring unit that acquires information related to a state of a vehicle as information to be provided to a driver; an urgency determining unit that determines urgency of the information acquired by the vehicle state acquiring unit; and a display mode deciding unit that decides a display mode so that the information will be displayed in a display area based on a result of determination by the urgency determining unit.

### TECHNICAL FIELD

The present invention relates to a vehicle-mounted display control device that provides a driver with information during traveling.

### BACKGROUND ART

A vehicle-mounted display control device provides a driver with information during traveling. Therefore, depending on a display method of the vehicle-mounted display control device, there are some cases where a display of the information provided to the driver is not sufficient.

As a solution to this problem, methods of providing the information may conceivably be changed depending on an attribute or a state of the driver. As vehicle-mounted display control devices that display the information in a more easily visible manner, vehicle-mounted display control devices that display the information in areas where there is less line-of-sight movement of the driver including a head-up display (HUD) that displays the information in sections in front of the driver (such as on a dashboard, a windshield, and a sun visor section) and an instrument panel section display are attracting attention.

Additionally, the HUD is a display device in which a plate (combiner) or a sheet with high reflectivity is installed in a front visual field area of the driver such as a windshield section, on a dashboard, and a sun visor section, whereby a navigation display such as characters is projected on the plate or sheet. Instrument panel section display is to display the information in an area behind a steering wheel.

For example, Patent Document 1 discloses a HUD-related technique for changing a display width of a displayed image in accordance with age information of a driver and whether or not the driver is wearing sunglasses.

In addition, Patent Document 2 discloses a HUD-related technique for changing a display position of a blind spot image input from each vehicle-mounted camera based on a visual field range of a driver.

### CITATION LIST

### Patent Document

Patent Document 1: Japanese Patent Application Laid-open No. 2010-140253

Patent Document 2: Japanese Patent Application Laid-open No. 2010-18201

### SUMMARY OF THE INVENTION

### Problems to be Solved by the Invention

A vehicle-mounted display control device provides a driver with the information during traveling. The information mentioned here refers to a warning related to a host vehicle, a warning related to a driver, a warning related to another vehicle, a speed of the host vehicle, a traveling state (other than speed) of the host vehicle, an air conditioning state of the host vehicle, a state of function settings of the host vehicle, a state of AV devices of the host vehicle, radio wave reception information, destination guidance information, information on routes to a destination, and a state of each display area.

However, a driver must direct his or her attention forward when driving. Therefore, depending on a display control method of the vehicle-mounted display control device, a burden of information acquisition by the driver increases. In addition, a burden of information acquisition of the instrument panel section or HUD during driving is low due to a display area being in proximity of a front field of view (windshield), while depending on the area where the information is displayed, visibility of the display or an information amount that can be acquired in the display area may differ in accordance with a state of the driver (an age group, a visual aid, a height of line of sight, or the like) and/or a situation of the vehicle.

Meanwhile, for example, with the conventional vehicle-mounted display control devices as disclosed in Patent Document 1 and Patent Document 2, even if changing the display width or display position in accordance with the age information of the driver is disclosed, there is a problem that no consideration is given to changing the display area or information amount to be displayed in view of the situation of the vehicle.

The present invention has been made in order to solve the above-described problem and an object thereof is to provide a vehicle-mounted display control device that enables the driver to more accurately acquire the information while driving by determining the state of the vehicle and changing the display area or display information amount.

### Means for Solving the Problems

A vehicle-mounted display control device according to the present invention is a vehicle-mounted display control device that provides a driver with information during traveling, and that includes: a vehicle state acquirer that acquires information related to a state of a vehicle as the information to be provided to the driver; an urgency determiner that determines urgency of the information acquired by the vehicle state acquiring unit; and a display mode decider that decides a display mode so that the information is displayed in a display area based on a result of determination by the urgency determiner.

### Effect of the Invention

According to the present invention, with respect to the information displayed by the vehicle, the area or an information amount to be displayed is changed, whereby visibility of display can be improved and, at the same time, sufficient information acquisition can be performed more accurately during driving.

### BRIEF DESCRIPTION OF THE DRAWINGS

FIG. 1 is a configuration diagram of a vehicle-mounted display control device according to Embodiment 1 of the present invention.

FIG. 2 is a flow chart showing the operation of the vehicle-mounted display control device according to Embodiment 1 of the present invention.

FIG. 3 is a diagram explaining display areas.

FIG. 4 is a configuration diagram of a vehicle-mounted display control device according to Embodiment 6 of the present invention.

FIG. 5 is a flow chart showing the operation of the vehicle-mounted display control device according to Embodiment 6 of the present invention.

FIG. 6 is a configuration diagram of a vehicle-mounted display control device which is the vehicle-mounted display control device described in Embodiments 1 to 5 with reference to FIG. 1 and which further includes a driver state acquiring unit and a driver state determining unit.

FIG. 7 is a configuration diagram of a vehicle-mounted display control device which is the vehicle-mounted display control device described in Embodiments 6 to 9 with reference to FIG. 4 and which further includes the driver state acquiring unit and driver state determining unit.

FIG. 8 is a flow chart showing the operation of the driver state acquiring unit, the driver state determining unit, and a display mode deciding unit of a vehicle-mounted display control device according to Embodiment 10 of the present invention.

### MODES FOR CARRYING OUT THE INVENTION

Hereinafter, embodiments of the present invention will be described in detail with reference to the accompanying drawings.

### Embodiment 1

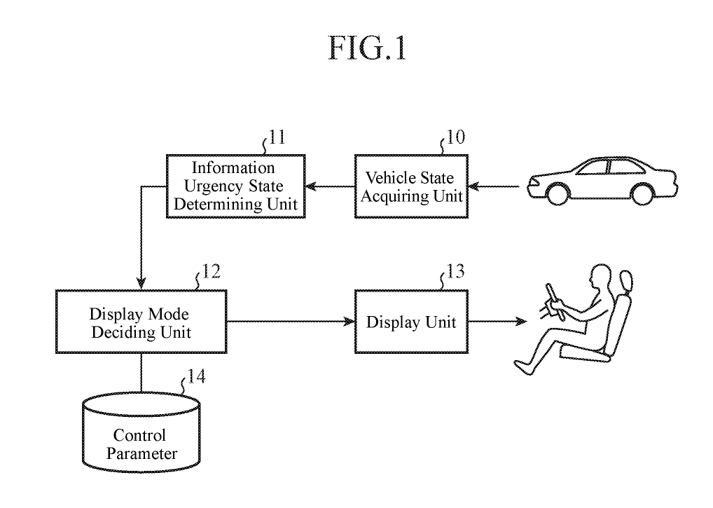

FIG. 1 is a configuration diagram of a vehicle-mounted display control device 1 according to Embodiment 1 of the present invention.

The vehicle-mounted display control device 1 according to present Embodiment 1 includes a vehicle state acquiring unit 10, an information urgency state determining unit 11, a display mode deciding unit 12, a display unit 13, and a control parameter 14.

Moreover, while a configuration in this case is adopted in which the vehicle-mounted display control device 1 includes the display unit 13, the display unit 13 may alternatively be provided outside of the vehicle-mounted display control device 1.

The vehicle state acquiring unit 10 acquires information related to a state of a vehicle. In present Embodiment 1, the vehicle state acquiring unit 10 is assumed to acquire a legal speed limit of a current location and a speed of a host vehicle.

The information urgency state determining unit 11 determines urgency of the information in accordance with the state of the vehicle acquired by the vehicle state acquiring unit 10.

The display mode deciding unit 12 decides a display area where the information is to be displayed or an amount of information to be displayed in the display area in accordance with the urgency of the information determined by the information urgency state determining unit 11.

The display unit 13 displays information to a driver. In this case, it is assumed that the information mentioned here refers to a warning related to the host vehicle, a warning related to the driver, a warning related to another vehicle, a speed of the host vehicle, a traveling state (other than speed) of the host vehicle, an air conditioning state of the host vehicle, a state of function settings of the host vehicle, a state of AV devices of the host vehicle, radio wave reception information, destination guidance information, information on routes to a destination, a state of each display area, and the like.

The control parameter 14 stores parameters of an appropriate display area corresponding to situations of the driver and the vehicle.

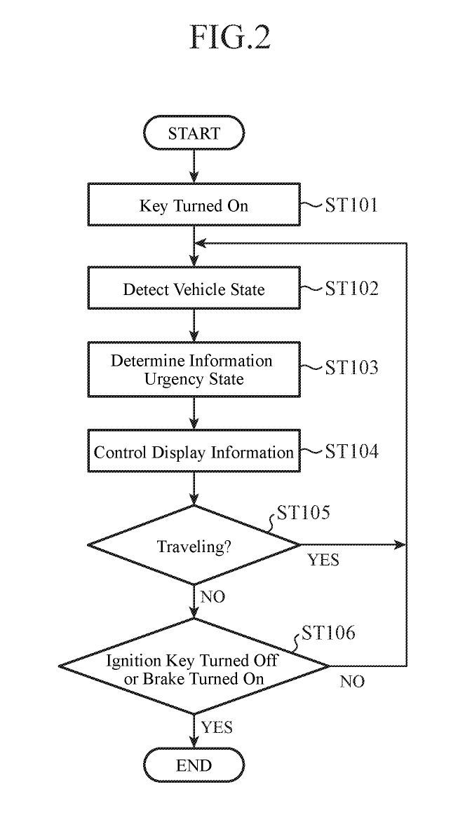

FIG. 2 is a flow chart showing the operation of the vehicle-mounted display control device 1 according to Embodiment 1 of the present invention.

When a control unit (not illustrated) determines that a key of the vehicle has been turned ON (step ST101), the vehicle state acquiring unit 10 acquires a state of the vehicle (step ST102).

In this case, as the information on the state of the vehicle, the vehicle state acquiring unit 10 acquires vehicle states such as a legal speed limit of a current location according to navigation and a speed of the host vehicle.

The information urgency state determining unit 11 receives the legal speed limit of the current location and the speed of the host vehicle acquired by the vehicle state acquiring unit 10 in step ST102 and determines the information urgency based on the received legal speed limit of the current location and the speed of the host vehicle (step ST103). Specifically, for example, a determination of “urgency: high” is made when the speed of the host vehicle is over the legal speed limit and a determination of “urgency: low” is made when the speed of the host vehicle is under the legal speed limit. A determination of high urgency is made, because the information must be provided more quickly when the speed of the vehicle is high. Moreover, the speed of the host vehicle to be used as a criterion of determination is not limited thereto and can be set as appropriate.

The display mode deciding unit 12 collates the information urgency determined by the information urgency state determining unit 11 in step ST103 with a determination rule and performs control of the display information to be displayed on the display unit 13 (step ST104). Additionally, the display information mentioned here refers to host vehicle speed information (external environment warning information) such as a numerical value of the speed of the host vehicle, meters, and icons, and the control mentioned here refers to deciding the display area and increasing or reducing the information amount with respect to the information to be displayed. Specifically, reference to the control parameter 14 is made and an appropriate display area and an appropriate information amount to be displayed are decided. For example, in the case of “urgency: high”, an external environment warning information display amount at a HUD upper area, a HUD lower area, or an on-dashboard area is increased or a display amount at an instrument panel area or a navigation area is reduced. This is because the HUD upper area, the HUD lower area, and the on-dashboard area are near the line of sight of the driver and enables the information to be readily acquired.

Note that these corresponding display areas and display amounts are registered in the control parameter in advance. In addition, in this case, while the decision is adapted to be made so that the display area and the information amount to be displayed will be changed in accordance with the urgency state, only the display area may be changed in accordance with the urgency state or only the information amount to be displayed may be changed in accordance with the urgency state.

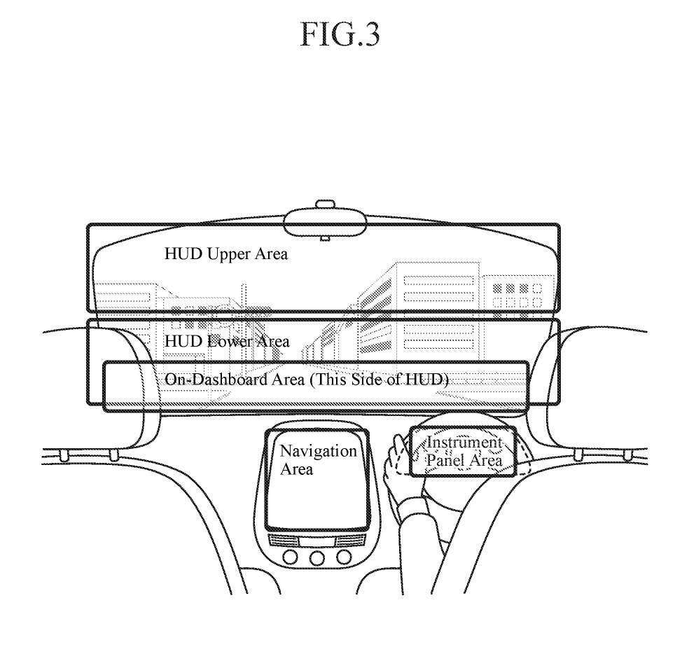

The display areas will now be described with reference to FIG. 3.

As shown in FIG. 3, the display areas refer to the five areas constituted by the navigation area, the instrument panel area, the on-dashboard area, the HUD upper area, and the HUD lower area. The navigation area refers to a navigation screen used for route guidance or the like, the instrument panel area refers to an instrument panel section provided in front of a driver's seat, the on-dashboard area refers to a laterally-long area immediately above the dashboard between a passenger's seat and the driver's seat, and the HUD upper area and the HUD lower area respectively refer to areas on an upper side and a lower side of the HUD. Note that it is assumed that the on-dashboard area is positioned on this side of the HUD.

Let us now return to the flow chart shown in FIG. 2.

The control unit determines whether or not the vehicle is traveling (step ST105), and when a determination is made that the vehicle is traveling (“YES” in step ST105), processing from step ST102 is repeated. On the other hand, when it is determined in step ST105 that the vehicle is not traveling (“NO” in step ST105), the control unit determines whether to be a state where the key of the vehicle has been turned OFF or a brake has been turned ON (step ST106). When it is determined in step ST106 that the key has been turned OFF or the brake has been turned ON (“YES” in step ST106), processing is terminated. On the other hand, when it is determined that the key has not been turned OFF and, at the same time, the brake has been turned OFF (“NO” in step ST106), return is made to step ST102 and subsequent processing is repeated. In other words, the vehicle state acquiring unit 10 performs detection at any time when the vehicle is traveling and does not perform detection when the vehicle is during stop.

As described above, according to Embodiment 1, for example, when the urgency is determined high based on the state of the vehicle, the information to be displayed by the vehicle is displayed in the display area in the upper section of the HUD where even suddenly-displayed information can be readily noticed, while when the urgency is not high, the information is displayed in the display area in the lower section of the HUD which enables the information to be readily acquired; thus, the speed information of the host vehicle to be displayed by the vehicle is changed in the display area to be displayed or the information amount to be displayed according to the urgency to be estimated from within or out of the legal speed limit, whereby necessary information can be made more visible in a situation with high urgency such as during traveling at a speed exceeding the legal speed limit.

### Embodiment 2

In Embodiment 1, an embodiment in which the vehicle state acquiring unit 10 acquires, as information on the state of the vehicle, the legal speed limit of the current location and the speed of the host vehicle has been described. In present Embodiment 2, an embodiment in which the vehicle state acquiring unit 10 acquires, as the information on the state of the vehicle, information on a distance between the destination and current location or a time required to reach the destination when navigation is set to provide route guidance will be described.

Since a configuration of a vehicle-mounted display control device 1 according to Embodiment 2 of the present invention is similar to the configuration of the vehicle-mounted display control device 1 described in Embodiment 1 with reference to FIG. 1, a redundant description will be omitted.

Since the operation of the vehicle-mounted display control device 1 according to Embodiment 2 of the present invention only differ from the operation described in Embodiment 1 with reference to FIG. 2 in contents of steps ST102 to ST104, only the different contents will be described.

In step ST102 shown in FIG. 2, in present Embodiment 2, the vehicle state acquiring unit 10 acquires the information on the distance between the destination and current location or the time required to reach the destination as the information on the state of the vehicle. Additionally, the distance between the destination and the current location or the time required to reach the destination has only to be calculated using techniques provided by existing navigation devices.

The information urgency state determining unit 11 receives the information on the distance between the destination and the current location or the time required to reach the destination acquired by the vehicle state acquiring unit 10 in step ST102 and determines information urgency based on the received contents (step ST103). Specifically, for example, based on the information acquired from the vehicle state acquiring unit 10, when the destination is within approximately 500 m from (when close to) the destination, a determination of “urgency: high” is made, and when the destination is 1 km or more from (when far from) the destination, a determination of “urgency: low” is made. In other words, when the destination is approaching, urgency of providing information is determined to be high in order to prevent an occurrence of an incident such as overlooking and driving past the destination. Additionally, while a determination whether to be near or far from the current location is made based on within 500 m and 1 km or more in this case, criteria of determination are not limited thereto and can be set as appropriate. In addition, as another example, for instance, a determination of “urgency: low” may be made when the time required to reach the destination as acquired from the vehicle state acquiring unit 10 is equal to or more than a prescribed time, and determination of “urgency: high” may be made when the time required to reach the destination is less than the prescribed time. In other words, when the time required to reach the destination is less than the prescribed time, a determination that the destination is approaching may be made and a determination that the urgency of providing information is high may be made in order to prevent the occurrence of the incident such as overlooking and driving past the destination. Even in this case, criteria of determination of the prescribed time can be set as appropriate.

The display mode deciding unit 12 collates the information urgency determined in step ST103 with a determination rule and performs control of display information to be displayed on the display unit 13 (step ST104). Additionally, the display information mentioned here refers to destination-related information (external environment warning information) such as destination information and information on routes to the destination, and the control mentioned here refers to deciding a display area and increasing or reducing an information amount with respect to the information to be displayed. Specifically, reference to the control parameter 14 is made and an appropriate display area and an appropriate information amount to be displayed are decided. For example, in the case of “urgency: high”, an external environment warning information display amount at the HUD upper area, the HUD lower area, or the on-dashboard area is increased and a display amount at the instrument panel area or the navigation area is reduced. In addition, in the case of “urgency: low”, the external environment warning information display amount at the HUD lower area, the on-dashboard area, the instrument panel area, or the navigation area is increased and the display amount at the HUD upper area is reduced. This is because the HUD upper area, the HUD lower area, and the on-dashboard area are near the line of sight of the driver and enables the information to be readily acquired. Note that these corresponding display areas are registered in the control parameter in advance. In addition, in this case, while the decision is adapted to be made so that the display area and the information amount to be displayed will be changed in accordance with the urgency state, only the display area may be changed in accordance with the urgency state or only the information amount to be displayed may be changed in accordance with the urgency state.

As described above, according to Embodiment 2, with respect to the destination-related information of the host vehicle, the display area or the information amount to be displayed is changed according to the urgency estimated based on the distance from the current location to the destination and the time required to reach the destination having been acquired as the state of the vehicle, whereby necessary information can be made more visible in a situation with high urgency such as when the vehicle exists in the periphery of the destination.

### Embodiment 3

In present Embodiment 3, as yet another embodiment, an embodiment in which the vehicle state acquiring unit 10 acquires vehicle internal environment information such as vehicle internal temperature or vehicle internal humidity as the information on the state of the vehicle will be described.

Since a configuration of a vehicle-mounted display control device 1 according to Embodiment 3 of the present invention is similar to the configuration of the vehicle-mounted display control device 1 described in Embodiments 1 and 2 with reference to FIG. 1, a redundant description will be omitted.

Since the operation of the vehicle-mounted display control device 1 according to Embodiment 3 of the present invention only differ from the operation described in Embodiments 1 and 2 with reference to FIG. 2 in contents of steps ST102 to ST104, only the different contents will be described.

In step ST102 shown in FIG. 2, in present Embodiment 3, the vehicle state acquiring unit 10 acquires a vehicle internal temperature as the information on the state of the vehicle. Additionally, the vehicle internal environment information such as vehicle internal temperature has only to be acquired using existing techniques.

The information urgency state determining unit 11 receives the information on the vehicle internal temperature acquired by the vehicle state acquiring unit 10 in step ST102 and determines information urgency based on the received contents (step ST103). Specifically, based on the information acquired from the vehicle state acquiring unit 10, for example, when it is 25° C. or higher in summer or 22° C., or lower in winter, a determination of “urgency: high” is made, and when it is 24° C. or lower in summer or 22° C. or higher in winter, a determination of “urgency: low” is made. This is because a high vehicle internal temperature in summer or a low vehicle internal temperature in winter may possibly cause problems regarding a driver's ability to concentrate on driving; accordingly, the determination of high urgency is made because there is a greater need to provide the driver with such information more promptly. Moreover, in this case, while the pieces of urgency are respectively determined based on whether it is 25° C. or higher or lower in summer, and whether it is 22° C. or lower or higher in winter, criteria of the determination are not limited thereto and can be set as appropriate. In addition, while the urgency is determined based on the vehicle internal temperature as the vehicle internal environment information in present Embodiment 3, the criterion is not limited thereto and the urgency may be determined based on vehicle internal humidity or urgency may be determined based on other environment information or on a combination of a plurality of types of environment information such as vehicle internal temperature and vehicle internal humidity.

The display mode deciding unit 12 collates the information urgency determined in step ST103 with a determination rule and performs control of display information to be displayed on the display unit 13 (step ST104). Additionally, the display information mentioned here refers to host vehicle air conditioning-related information (external environment warning information) such as vehicle internal temperature or vehicle internal humidity and an air conditioning state of the host vehicle, and the control mentioned here refers to determining a display area and increasing or reducing an information amount with respect to the information to be displayed. Specifically, reference to the control parameter 14 is made and an appropriate display area and an appropriate information amount to be displayed are decided. For example, in the case of “urgency: high”, an external environment warning information display amount at the HUD upper area, the HUD lower area, or the on-dashboard area is increased and a display amount at the instrument panel area or the navigation area is reduced. In addition, in the case of “urgency: low”, the external environment warning information display amount at the HUD lower area, the on-dashboard area, the instrument panel area, or the navigation area is increased and the display amount at the HUD upper area is reduced. This is because the HUD upper area, the HUD lower area, and the on-dashboard area are near the line of sight of the driver and enables the information to be readily acquired. Note that these corresponding display areas are registered in the control parameter in advance. In addition, in this case, while the decision is adapted to be made so that the display area and the information amount to be displayed will be changed in accordance with the urgency state, only the display area may be changed in accordance with the urgency state or only the information amount to be displayed may be changed in accordance with the urgency state.

As described above, according to Embodiment 3, with respect to the vehicle air conditioning information to be displayed by the vehicle, the display area or the information amount to be displayed is changed according to the urgency estimated based on the vehicle state information such as vehicle internal temperature and vehicle internal humidity, whereby necessary information can be made more visible in a situation with high urgency such as when the temperature inside the vehicle is high in summer.

### Embodiment 4

In present Embodiment 4, as yet another embodiment, an embodiment in which the vehicle state acquiring unit 10 acquires a vehicle front state as the information on the state of the vehicle will be described.

Since a configuration of a vehicle-mounted display control device 1 according to Embodiment 4 of the present invention is similar to the configuration of the vehicle-mounted display control device 1 described in Embodiments 1 to 3 with reference to FIG. 1, a redundant description will be omitted.

Since the operation of the vehicle-mounted display control device 1 according to Embodiment 4 of the present invention only differ from the operation described in Embodiments 1 to 3 with reference to FIG. 2 in contents of steps ST102 to ST104, only the different contents will be described.

In step ST102 shown in FIG. 2, in present Embodiment 4, the vehicle state acquiring unit 10 acquires the vehicle front state as the information on the state of the vehicle. Specifically, the vehicle state acquiring unit 10 acquires information on a pedestrian or an oncoming vehicle in front of the vehicle as the vehicle front state from video obtained by an imaging camera attached to the front of the vehicle.

The information urgency state determining unit 11 receives the vehicle front state information acquired by the vehicle state acquiring unit 10 in step ST102 and determines information urgency based on the received contents (step ST103). Specifically, for example, based on the information acquired from the vehicle state acquiring unit 10, a determination of “urgency: high” is made when an object of attention such as a pedestrian crossing or an oncoming vehicle departing from its lane is detected, and a determination of “urgency: low” is made in the other cases. This is because the presence of a crossing pedestrian or an oncoming vehicle departing from its lane outside the vehicle increases risk; thus, the determination of high urgency is made because there is a greater need to provide the driver with such information more promptly. Moreover, in this case, while the urgency is adapted to be determined based on the pedestrian crossing or the oncoming vehicle departing from its lane, criterion of the determination is not limited thereto and can be set as appropriate.

The display mode deciding unit 12 collates the information urgency determined in step ST103 with a determination rule and performs control of display information to be displayed on the display unit 13 (step ST104). Additionally, the display information mentioned here refers to external environment warning information related to the oncoming vehicle or the pedestrian, and the control mentioned here refers to deciding a display area and increasing or reducing an information amount with respect to the information to be displayed. Specifically, reference to the control parameter 14 is made and an appropriate display area and an appropriate information amount to be displayed are decided. For example, in the case of “urgency: high”, an external environment warning information display amount at the HUD upper area, the HUD lower area, or the on-dashboard area is increased and a display amount at the instrument panel area or the navigation area is reduced. In addition, in the case of “urgency: low”, the external environment warning information display amount at the HUD lower area, the on-dashboard area, the instrument panel area, or the navigation area is increased and the display amount at the HUD upper area is reduced. This is because the HUD upper area, the HUD lower area, and the on-dashboard area are near the line of sight of the driver and enables the information to be readily acquired. Note that these corresponding display areas are registered in the control parameter in advance. In addition, in this case, while the decision is adapted to be made so that the display area and the information amount to be displayed will be changed in accordance with the urgency state, only the display area may be changed in accordance with the urgency state or only the information amount to be displayed may be changed in accordance with the urgency state.

As described above, according to Embodiment 4, with respect to the external environment warning information to be displayed by the vehicle, the display area or the information amount to be displayed is changed according to the urgency estimated based on the vehicle front state, whereby necessary information can be made more visible in a situation with high urgency such as pedestrian crossing.

### Embodiment 5

In present Embodiment 5, as yet another embodiment, an embodiment in which the vehicle state acquiring unit 10 acquires a vehicle rear state as the information on the state of the vehicle will be described.

Since a configuration of a vehicle-mounted display control device 1 according to Embodiment 5 of the present invention is similar to the configuration of the vehicle-mounted display control device 1 described in Embodiments 1 to 4 with reference to FIG. 1, a redundant description will be omitted.

Since the operation of the vehicle-mounted display control device 1 according to Embodiment 5 of the present invention only differ from the operation described in Embodiments 1 to 4 with reference to FIG. 2 in contents of steps ST102 to ST104, only the different contents will be described.

In step ST102 shown in FIG. 2, in present Embodiment 5, the vehicle state acquiring unit 10 acquires the vehicle rear state as the information on the state of the vehicle. Specifically, the vehicle state acquiring unit 10 acquires information on a vehicle, a motorcycle, a bicycle or the like overtaking or approaching from behind as the vehicle rear state from video obtained by an imaging camera attached to the rear of the vehicle.

The information urgency state determining unit 11 receives the vehicle front state information acquired by the vehicle state acquiring unit 10 in step ST102 and determines information urgency based on the received contents (step ST103). Specifically, for example, based on the information acquired from the vehicle state acquiring unit 10, a determination of “urgency: high” is made when the vehicle, the motorcycle, the bicycle or the like overtaking or approaching from behind is detected, and a determination of “urgency: low” is made in the other cases. This is because the vehicle, the motorcycle, the bicycle or the like overtaking or approaching from behind the vehicle increases risk; thus, the determination of high urgency is made because there is a greater need to provide the driver with such information more promptly. Moreover, while the urgency is adapted to be determined based on the vehicle in this case, the motorcycle, the bicycle or the like overtaking or approaching from behind, criteria of determination are not limited thereto and can be set as appropriate.

The display mode deciding unit 12 collates the information urgency determined in step ST103 with a determination rule and performs control of display information to be displayed on the display unit 13 (step ST104). Additionally, the display information mentioned here refers to external environment warning information related to a vehicle, a motorcycle, a bicycle behind the host vehicle, and the control mentioned above refers to deciding a display area and increasing or reducing an information amount with respect to the information to be displayed. Specifically, reference to the control parameter 14 is made and an appropriate display area and an appropriate information amount to be displayed are decided. For example, in the case of “urgency: high”, an external environment warning information display amount at the HUD upper area, the HUD lower area, or the on-dashboard area is increased and a display amount at the instrument panel area or the navigation area is reduced. In addition, in the case of “urgency: low”, the external environment warning information display amount at the HUD lower area, the on-dashboard area, the instrument panel area, or the navigation area is increased and a display amount at the HUD upper area is reduced. This is because the HUD upper area, the HUD lower area, and the on-dashboard area are near the line of sight of the driver and enables information to be readily acquired. Note that these corresponding display areas are registered in the control parameter in advance. In addition, while the display area and the information amount to be displayed are changed and decided in accordance with an urgency state, only the display area may be changed in accordance with the urgency state or only the information amount to be displayed may be changed in accordance with the urgency state.

As described above, according to Embodiment 5, with respect to the external environment warning information to be displayed by the vehicle, the display area or the information amount to be displayed is changed according to the urgency estimated based on the vehicle rear state, whereby necessary information can be made more visible in a situation with high urgency such as the motorcycle overtaking from behind.

### Embodiment 6

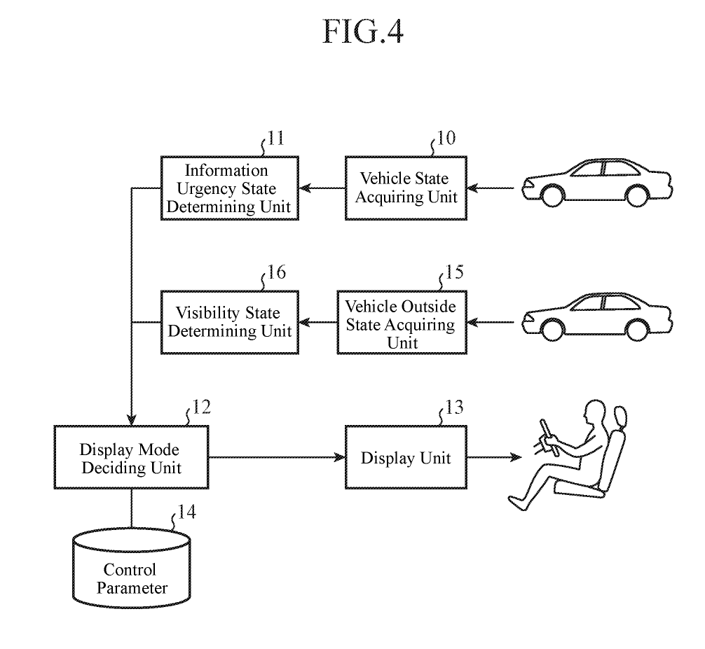

FIG. 4 is a configuration diagram of a vehicle-mounted display control device 1 according to Embodiment 6 of the present invention.

The vehicle-mounted display control device 1 according to present Embodiment 6 only differs from the configuration of the vehicle state acquiring unit 10 described in Embodiments 1 to 5 in that a vehicle outside state acquiring unit 15 and a visibility state determining unit 16 are additionally provided.

However, with respect to components shown in FIG. 4 which are similar to those described in Embodiments 1 to 5 with reference to FIG. 1, a redundant description will be omitted.

The vehicle outside state acquiring unit 15 acquires information on a state outside a vehicle. Note that in present Embodiment 6, the vehicle outside state acquiring unit 15 is assumed to acquire illuminance outside the vehicle.

The visibility state determining unit 16 determines a visibility state of a driver based on the information acquired by the vehicle outside state acquiring unit 15.

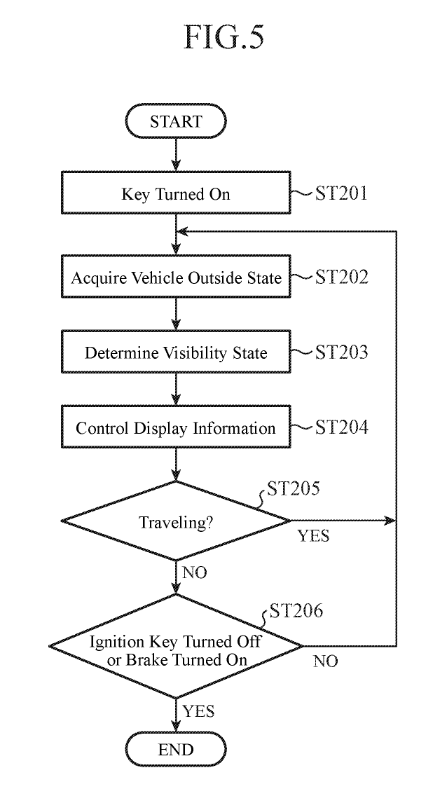

FIG. 5 is a flow chart showing the operation of the vehicle-mounted display control device 1 according to Embodiment 6 of the present invention.

When a control unit (not illustrated) determines that a key of the vehicle has been turned ON (step ST201), the vehicle outside state acquiring unit 15 acquires the state outside the vehicle (step ST202).

In this case, the vehicle outside state acquiring unit 15 acquires the illuminance outside the vehicle at each of the display areas as information on the state outside the vehicle. For example, the illuminance outside the vehicle may be obtained by images of imaging cameras at the front of the vehicle or may be acquired by any other means.

The visibility state determining unit 16 receives the illuminance outside the vehicle acquired by the vehicle outside state acquiring unit 15 in step ST202 and determines the visibility state of the driver based on the received illuminance outside the vehicle (step ST203). Specifically, for example, the illuminance outside the vehicle that constitutes a background of the HUD display areas is determined based on whether the illuminance is “dazzling” or “dark”. When the background of each display area or, in other words, illuminance of an image captured by the imaging camera at the front of the vehicle is equal to or higher than a reference level, a determination that a visibility state of the display area is “dazzling” is made and, when the illuminance is less than or equal to the reference level, a determination of “dark” is made. In this case, the illuminance used as the reference level of determination may be, for example, 2000 lux (illuminance corresponding to sunlight in one hour after sunrise on overcast day). Additionally, the illuminance used as the reference level of the determination is not limited thereto and can be set as appropriate. In addition, a color tone of a background may be determined in addition to the illuminance of the background.

The display mode deciding unit 12 collates the visibility state determined in step ST203 with a determination rule and performs control of display information to be displayed on the display unit 13 (step ST204). Additionally, the display information mentioned here refers to, for example, the display information described in Embodiments 1 to 5. In addition, the control refers to deciding a display area and increasing or reducing an information amount with respect to the information to be displayed. Specifically, reference to the control parameter 14 is made and an appropriate display area and an appropriate information amount to be displayed are decided. For example, when the visibility state of each area of HUD display is “dark”, the display of the area is increased, and when all areas of HUD display is “dazzling”, the display in the on-dashboard area, the instrument panel area, or the navigation area is increased. The corresponding display areas and information amounts to be displayed are registered in the control parameter in advance. In addition, in this case, while the decision is adapted to be made so that the information amount to be displayed will be changed in accordance with the vehicle outside state, the display area may be changed in accordance with the vehicle outside state or both the display area and the information amount to be displayed may be changed in accordance with the vehicle outside state.

In addition, on this occasion, the display mode deciding unit 12 decides an appropriate display area and information amount to be displayed by also taking into consideration information urgency determined by the information urgency state determining unit 11 based on vehicle front state information received from the vehicle state acquiring unit 10. Specifically, for example, when there exists information for which “urgency: high” has been determined by the information urgency state determining unit 11, the display information is controlled such that the information determined “urgency: high” is preferentially displayed. In addition, for example, an appropriate display area can be decided when the traffic information display is present in the background of the HUD display area, or an appropriate information amount can be decided by determining the urgency of the vehicle state information received from the vehicle state acquiring unit 10 and subsequently determining a visibility state. Specifically, in the case of “urgency: high”, first, the HUD upper area, the HUD lower area, or the on-dashboard area is selected as a candidate of the display area of the information. Next, when it is determined that all the areas of HUD display are “dazzling”, the information is displayed in the on-dashboard area among three selected areas. Alternatively, by prioritizing the determination regarding the visibility state, a decision to display the information in the instrument panel area may be made without using the candidate of the display areas selected based on the urgency of the vehicle state information. However, since specific operations of the vehicle state acquiring unit 10 and the information urgency state determining unit 11 are the same as those in Embodiments 1 to 5, detailed descriptions thereof will be omitted.

A color tone of the display can conceivably be changed in accordance with a color tone of the background. For example, control can be performed such that a complementary color of the color tone of the background of HUD display is adopted as the color of characters (when the background is red, yellow-green characters are used).

The control unit determines whether or not the vehicle is traveling (step ST205), and when a determination is made that the vehicle is traveling (“YES” in step ST205), processing from step ST202 is repeated. On the other hand, when it is determined in step ST205 that the vehicle is not traveling (“NO” in step ST205), the control unit determines whether there is a state where the key of the vehicle has been turned OFF or a brake has been turned ON (step ST206). When it is determined in step ST206 that the key of the vehicle has been turned OFF or the brake has been turned ON (“YES” in step ST206), processing is terminated. On the other hand, when it is determined that the key of the vehicle has not been turned OFF and, at the same time, the brake has been turned OFF (“NO” in step ST206), a return is made to step ST202 and subsequent processing is repeated. In other words, the vehicle state acquiring unit 10 performs detection at any time when the vehicle is traveling and does not perform detection when the vehicle is during stop.

Moreover, while the vehicle-mounted display control device 1 described in Embodiments 1 to 5 is further provided with the vehicle outside state acquiring unit 15 and the visibility state determining unit 16, and the decision of the display area of the information to be displayed and the increase or decrease of the information amount of the information to be displayed are controlled based on the urgency of the information and the visibility state of the driver, this configuration is not restrictive. Alternatively, a configuration may be adopted in which the vehicle state acquiring unit 10 and the information urgency state determining unit 11 shown in FIG. 4 are not provided, and the decision of the display area of the information to be displayed and the increase or decrease of the information amount of the information to be displayed are controlled based solely on the visibility state of the driver that is determined by the visibility state determining unit 16 from information on the state outside the vehicle acquired by the vehicle outside state acquiring unit 15. In other words, the vehicle-mounted display control device can also be configured to include: the vehicle outside state acquiring unit that acquires information related to the state outside the vehicle; the visibility state determining unit that determines the visibility state of the driver based on the information acquired by the vehicle outside state acquiring unit; and the display mode deciding unit that changes the display area where the information is to be displayed or changes the display information amount based on a result of determination by the visibility state determining unit.

As described above, according to Embodiment 6, with respect to the information to be displayed by the vehicle, since an appropriate information amount is displayed in an easily viewable area according to the background illuminance of HUD display, the driver can acquire the information more accurately.

### Embodiment 7

In Embodiment 6, the embodiment in which the vehicle outside state acquiring unit 15 acquires, as the information on the state outside the vehicle, the illuminance outside the vehicle has been described. In present Embodiment 7, an embodiment in which the vehicle outside state acquiring unit 15 acquires, as the information on the state outside the vehicle, the presence or absence of a traffic information display will be described.

Since a configuration of a vehicle-mounted display control device 1 according to Embodiment 7 of the present invention is similar to the configuration of the vehicle-mounted display control device 1 described in Embodiment 6 with reference to FIG. 4, a redundant description will be omitted.

Since the operation of the vehicle-mounted display control device 1 according to Embodiment 7 of the present invention only differ from the operation described in Embodiment 6 with reference to FIG. 5 in contents of steps ST202 to ST204, only the different contents will be described.

In step ST202 shown in FIG. 5, in present Embodiment 7, the vehicle outside state acquiring unit 15 acquires the presence or absence of the traffic information display in a background of each HUD display area as the information on the state outside the vehicle. Specifically, the presence or absence of the traffic information display may be acquired based on an image captured by an imaging camera at the front of the vehicle or the presence or absence of the traffic information display may be acquired by any other methods.

The visibility state determining unit 16 receives the presence or absence of the traffic information display acquired by the vehicle outside state acquiring unit 15 in step ST202 and determines a visibility state based on the received contents (step ST203). Specifically, for example, based on the presence or absence of the traffic information display acquired from the vehicle outside state acquiring unit 15, the visibility state is determined to be poor when the traffic information display outside the vehicle is “present” in the backgrounds of the respective HUD display areas, and the visibility state is determined to be good when “absent”. Note that the traffic information display to be an object of determination in this case refers to a traffic signal, a speed display, a traffic sign, or the like and is an example of a display obstacle in the present invention.

The display mode deciding unit 12 collates the visibility state determined in step ST203 with a determination rule and performs control of display information to be displayed on the display unit 13 (step ST204). Additionally, the display information mentioned here refers to, for example, the display information described in Embodiments 1 to 5. In addition, the control refers to deciding a display area and increasing or reducing an information amount with respect to the information to be displayed. Specifically, reference to the control parameter 14 is made and an appropriate display area and an appropriate information amount to be displayed are decided. For example, in this case, with respect to the HUD display area, control is performed so as not to display the information in the area or reduce an amount of information to be displayed in the area when the traffic information display exists in the background of the area. Alternatively, control may be performed such that an icon or the like is displayed superimposed on the traffic information display. The corresponding display areas and information amounts to be displayed are registered in the control parameter in advance. In addition, in this case, while the decision is adapted to be made so that the display area and the information amount to be displayed will be changed in accordance with the vehicle outside state, only the display area may be changed in accordance with the vehicle outside state or only the information amount to be displayed may be changed in accordance with the vehicle outside state.

As described above, according to Embodiment 7, with respect to the information to be displayed by the vehicle, when the traffic information display is present in the background of the HUD display area, it can be adapted that no display is made in that area, which enables to perform more accurate information provision.

In addition, according to Embodiment 7, with respect to the information to be displayed by the vehicle, when the traffic information display is present in the background of the HUD display area, the traffic information display can be highlighted and conveyed to the driver by displaying superimposedly an icon or the like. Accordingly, the attention of the driver can be drawn to the traffic information display.

Moreover, while the vehicle-mounted display control device 1 described in Embodiments 1 to 5 is configured to additionally include the vehicle outside state acquiring unit 15 and the visibility state determining unit 16 in the description above, in a similar manner to Embodiment 6, a configuration may be adopted in which the vehicle state acquiring unit 10 and the information urgency state determining unit 11 shown in FIG. 4 are not provided and the decision of the display area of information to be displayed and the increase or decrease of the information amount of the information to be displayed are controlled based solely on the visibility state of the driver that is determined by the visibility state determining unit 16 from the information on the state outside the vehicle acquired by the vehicle outside state acquiring unit 15.

### Embodiment 8

In present Embodiment 8, as yet another embodiment, an embodiment in which the vehicle outside state acquiring unit 15 acquires the presence or absence of an obstacle such as a pedestrian present in front of the driver as the information on the state outside the vehicle will be described. In this case, the obstacle such as the pedestrian is an example of a display obstacle in the present invention.

Since a configuration of a vehicle-mounted display control device 1 according to Embodiment 8 of the present invention is similar to the configuration of the vehicle-mounted display control device 1 described in Embodiments 6 and 7 with reference to FIG. 4, a redundant description will be omitted.

Since the operation of the vehicle-mounted display control device 1 according to Embodiment 8 of the present invention only differ from the operation described in Embodiments 6 and 7 with reference to FIG. 5 in contents of steps ST202 to ST204, only the different contents will be described.

In step ST202 shown in FIG. 5, in present Embodiment 8, the vehicle outside state acquiring unit 15 acquires the presence or absence of an obstacle in the background of each HUD display area as the information on the state outside the vehicle. Specifically, the presence or absence of the obstacle may be acquired based on an image captured by an imaging camera at the front of the vehicle or the presence or absence of the obstacle may be acquired by any other methods.

The visibility state determining unit 16 receives the presence or absence of the obstacle acquired by the vehicle outside state acquiring unit 15 in step ST202 and determines a visibility state based on the received contents (step ST203). Specifically, for example, based on the presence or absence of the obstacle acquired from the vehicle outside state acquiring unit 15, the visibility state is determined to be poor when the obstacle outside the vehicle is “present” in the backgrounds of the respective HUD display areas, and the visibility state is determined to be good when the obstacle is “absent”.

The display mode deciding unit 12 collates the visibility state determined in step ST203 with a determination rule and performs control of display information to be displayed on the display unit 13 (step ST204). Additionally, the display information mentioned above refers to, for example, the display information described in Embodiments 1 to 5. In addition, the control refers to deciding a display area and increasing or reducing an information amount with respect to the information to be displayed. Specifically, reference to the control parameter 14 is made and an appropriate display area and an appropriate information amount to be displayed are decided. For example, with respect to the HUD display area, control is performed so as not to display the information in the area or reduce an amount of information to be displayed in the area when the obstacle exists in the background of the area. Alternatively, control may be performed such that an icon or the like is displayed superimposedly on the obstacle. The corresponding display areas and information amounts to be displayed are registered in the control parameter in advance. In addition, in this case, while the decision is adapted to be made so that the display area and the information amount to be displayed will be changed in accordance with the vehicle outside state, only the display area may be changed in accordance with the vehicle outside state or only the information amount to be displayed may be changed in accordance with the vehicle outside state.

As described above, according to Embodiment 8, with respect to the information to be displayed by the vehicle, when the obstacle or pedestrian is present in the background of the HUD display area, it can be adapted that no display is made in that area, which enables to perform more accurate information provision.

In addition, according to Embodiment 8, with respect to the information to be displayed by the vehicle, when the obstacle or pedestrian is present in the background of the HUD display areas, the obstacle or pedestrian can be highlighted and conveyed to the driver by displaying superimposedly an icon or the like. Accordingly, the attention of the driver can be drawn to the obstacle or the pedestrian.

Moreover, while the vehicle-mounted display control device 1 described in Embodiments 1 to 5 is configured to additionally include the vehicle outside state acquiring unit 15 and the visibility state determining unit 16 in the description above, in a similar manner to Embodiments 6 and 7, a configuration may be adopted in which the vehicle state acquiring unit 10 and the information urgency state determining unit 11 shown in FIG. 4 are not provided and the decision of the display area of information to be displayed and the increase or decrease of the information amount of the information to be displayed are controlled based solely on the visibility state of the driver that is determined by the visibility state determining unit 16 from the information on the state outside the vehicle acquired by the vehicle outside state acquiring unit 15.

### Embodiment 9

In present Embodiment 9, as yet another embodiment, an embodiment in which the vehicle outside state acquiring unit 15 acquires peripheral facility information as the information on a state outside a vehicle will be described.

Since a configuration of a vehicle-mounted display control device 1 according to Embodiment 9 of the present invention is similar to the configuration of the vehicle-mounted display control device 1 described in Embodiments 6 to 8 with reference to FIG. 4, a redundant description will be omitted.

Since the operation of the vehicle-mounted display control device 1 according to Embodiment 9 of the present invention only differ from the operation described in Embodiments 6 to 8 with reference to FIG. 5 in contents of steps ST202 to ST204, only the different contents will be described.

In step ST202 shown in FIG. 5, in present Embodiment 9, the vehicle outside state acquiring unit 15 acquires current location peripheral facility information from map data stored in advance as the information on the state outside the vehicle. Note that, for example, the current location peripheral facility information refers to information indicating that the current location is a shopping street, in front of an elementary school, a residential area, a main street, an expressway, a street with no peripheral facilities, or the like.

The visibility state determining unit 16 receives the current location peripheral facility information acquired by the vehicle outside state acquiring unit 15 in step ST202 and determines a visibility state based on the received contents (step ST203). Specifically, for example, a determination on whether a degree of attention in front of a vehicle is a “front near-point attention location” or a “front far-point attention location” is made based on the current location peripheral facility information acquired from the vehicle outside state acquiring unit 15. For example, the determination of the “front near-point attention location” is made when the current location is the shopping street, in front of the elementary school, or the residential area, and the determination of the “front far-point attention location” is made when the current location is the main street, the expressway, or the street with no peripheral facilities. Note that it is assumed that whether the determination of the “front near-point attention location” or the determination of the “front far-point attention location” is made can be appropriately set in advance.

The display mode deciding unit 12 collates the visibility state determined in step ST203 with a determination rule and performs control of the display unit 13 (step ST204). Additionally, the control mentioned here refers to deciding a display area and increasing or reducing an information amount with respect to the information to be displayed. Specifically, reference to the control parameter 14 is made and an appropriate display area and an appropriate information amount to be displayed are decided. For example, in this case, with respect to the HUD display area, control is performed such that no display is performed or a display amount is reduced to the HUD display area in the case of the “front near-point attention location,” and that no display is performed or the display amount is reduced to the navigation area and the instrument panel area in the case of the “front far-point attention location.” In other words, in a state where the driver must devote attention to a near point, display on the HUD upper area which causes the line of sight to be directed far away is avoided, and in a state where the driver must devote attention to a far point, display on the navigation area and the instrument panel area which causes the line of sight to be directed downward is avoided. Note that the corresponding display areas and information amounts to be displayed are registered in the control parameter in advance. In addition, in this case, while the decision is adapted to be made so that the display area and the information amount to be displayed will be changed in accordance with the vehicle outside state, only the display area may be changed in accordance with the vehicle outside state or only the information amount to be displayed may be changed in accordance with the vehicle outside state.

As described above, according to Embodiment 9, with respect to the information to be displayed by the vehicle, the area where the information is to be displayed or the information amount to be displayed is changed depending on whether the type of the current location is the location where attention must be focused on the near point in front or the location where attention must be focused on the far point in front, which enables to provide more accurate information.

Moreover, while the vehicle-mounted display control device 1 described in Embodiments 1 to 5 is configured to additionally include the vehicle outside state acquiring unit 15 and the visibility state determining unit 16 in the description above, in a similar manner to Embodiments 6 and 7, a configuration may be adopted in which the vehicle state acquiring unit 10 and the information urgency state determining unit 11 shown in FIG. 4 are not provided, and the decision of the display area of the information to be displayed and the increase or decrease of the information amount are controlled based solely on the visibility state of the driver that is determined by the visibility state determining unit 16 from the information on the state outside the vehicle acquired by the vehicle outside state acquiring unit 15.

### Embodiment 10

Next, an embodiment which, in addition to Embodiments 1 to 9, further acquires the information on the state of the driver and provides the information more accurately in consideration of the state of the driver will be described.

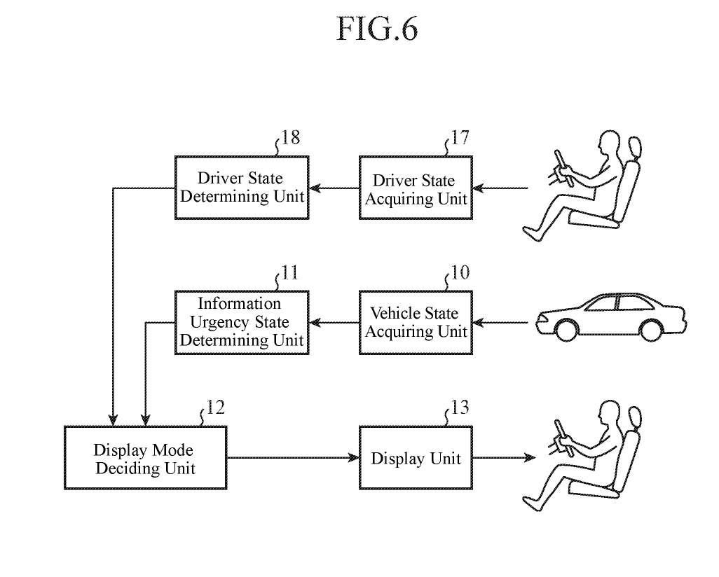

FIG. 6 is a configuration diagram of a vehicle-mounted display control device 1 in which the vehicle-mounted display control device 1 described in Embodiments 1 to 5 with reference to FIG. 1 further includes a driver state acquiring unit 17 and a driver state determining unit 18.

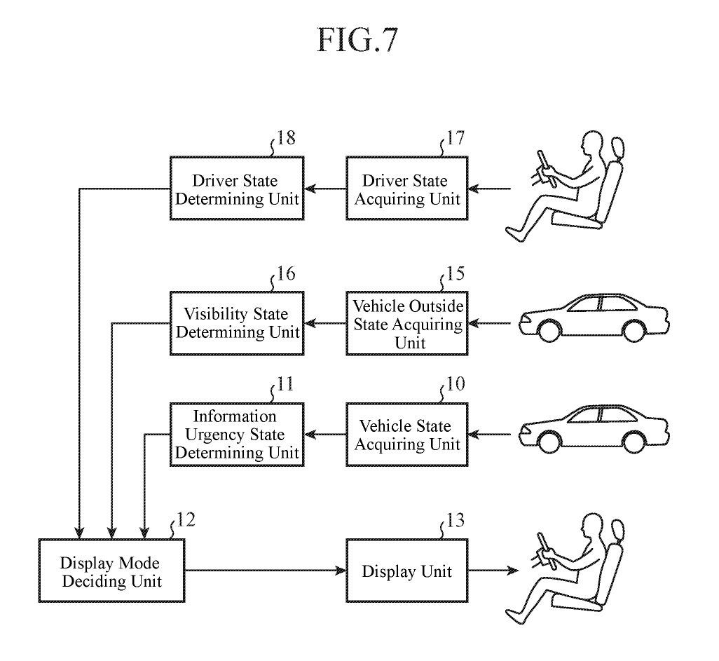

FIG. 7 is a configuration diagram of a vehicle-mounted display control device 1 in which the vehicle-mounted display control device 1 described in Embodiments 6 to 9 with reference to FIG. 4 further includes the driver state acquiring unit 17 and the driver state determining unit 18.

However, with respect to components in FIGS. 6 and 7 which are similar to those described in Embodiments 1 to 9, a redundant description will be omitted.

The driver state acquiring unit 17 acquires information related to a state of a driver.

The driver state determining unit 18 determines the state of the driver based on the information on the state of the driver acquired by the driver state acquiring unit 17.

The display mode deciding unit 12 decides an information amount to be displayed or a display area in accordance with the information on the state of the driver acquired by the driver state acquiring unit 17. In addition, in an urgent state, the information amount to be displayed or the display area is decided in accordance with the urgency. Furthermore, the information amount to be displayed or the display area is decided in accordance with a state outside the vehicle.

In FIG. 6, since the operation in which the vehicle state acquiring unit 10 acquires the information on the state of the vehicle, the information urgency state determining unit 11 determines urgency of the information based on the state of the vehicle, and the display mode deciding unit 12 decides the display area or the information amount to be displayed based on a result of determination by the information urgency state determining unit 11 are the same as that described in Embodiments 1 to 5, a detailed description thereof will be omitted. In addition, in FIG. 7, since the operation in which the display mode deciding unit 12 decides the display area or the information amount to be displayed based on a result of determination of a visibility state of the driver having been determined using the vehicle outside state acquiring unit 15 and the visibility state determining unit 16, and a result of determination of the urgency of information having been determined using the vehicle state acquiring unit 10 and the information urgency state determining unit 11 are the same as that described in Embodiments 6 to 9, a detailed description thereof will be omitted. The operations of the driver state acquiring unit 17 and the driver state determining unit 18 as well as the operation of the display mode deciding unit 12 in response to the operation of the driver state determining unit 18 will now be described.

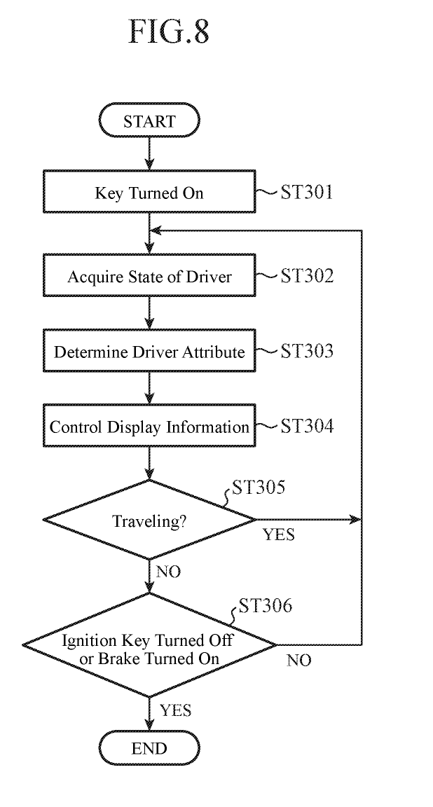

FIG. 8 is a flow chart showing the operation of the driver state acquiring unit 17, the driver state determining unit 18, and the display mode determining unit 12 of the vehicle-mounted display control device 1 according to Embodiment 10 of the present invention.

When a control unit (not illustrated) determines that a key of the vehicle has been turned ON (step ST301), the driver state acquiring unit 17 acquires a driver's state (step ST302).

In this case, the driver state acquiring unit 17 acquires a height of a line of sight of the driver as information on the state of the driver. Specifically, a photograph of the driver may be taken by a camera installed in the vehicle, and the height of the line of sight of the driver may be detected from positions of the eyes of the photographed driver. Moreover, this is merely an example and the height of the line of sight of the driver may be detected using any other methods.

The driver state determining unit 18 receives the line-of-sight height acquired by the driver state acquiring unit 17 in step ST302 and determines a driver attribute or, in other words, a state of the driver based on the received line-of-sight height (ST303). Specifically, for example, based on the line-of-sight height acquired from the driver state acquiring unit 17, a determination of “line-of-sight height: high” is made when the line-of-sight height from a seat surface of the vehicle to the line of sight is 80 cm or more and a determination of “line-of-sight height: low” is made when the line-of-sight height is 80 cm or less. Moreover, while the “line-of-sight height: high” is determined when the line-of-sight height is 80 cm or more and the “line-of-sight height: low” is determined when the line-of-sight height is 80 cm or less, this is not restrictive, and the line-of-sight height whether or not the line of sight is determined to be high can be set as appropriate.

The display mode determining unit 12 collates the state of the driver determined in step ST103 with a determination rule and performs control of the display unit 13 (step ST304). Additionally, the control mentioned here refers to determining the display area and increasing or reducing the information amount with respect to the information to be displayed. Specifically, reference to the control parameter 14 is made and an appropriate display area and an appropriate information amount to be displayed are decided. For example, when the determination of “line-of-sight height: high” is made with respect to the driver, the HUD upper area is assumed to be the appropriate display area. On the other hand, when the determination of “line-of-sight height: low” is made with respect to the driver, the HUD lower area, the on-dashboard area, and the instrument panel area are assumed to be the appropriate display areas. These corresponding display areas are registered in the control parameter in advance.

Moreover, only the display area may be changed based on the state of the driver as described above or only the information amount to be displayed may be changed. Alternatively, both the display area and the information amount to be displayed may be changed.

The control unit determines whether or not the vehicle is traveling (step ST305), and when a determination is made that the vehicle is traveling (“YES” in step ST305), processing from step ST302 is repeated. On the other hand, when it is determined in step ST305 that the vehicle is not traveling (“NO” in step ST305), the control unit determines whether there is a state where the key of the vehicle has been turned OFF or a brake has been turned ON (step ST306). When it is determined in step ST306 that the key of the vehicle has been turned OFF or the brake has been turned ON (“YES” in step ST306), processing is terminated. On the other hand, when it is determined that the key of the vehicle has not been turned off and, at the same time, the brake has been turned OFF (“NO” in step ST306), a return is made to step ST302 and subsequent processing is repeated. In other words, the driver state acquiring unit 17 performs detection at any time when the vehicle is traveling and does not perform detection when the vehicle is during stop.

As described above, when the driver state acquiring unit 17 and the driver state determining unit 18 are further provided therefor, the information taking the driver's state into consideration can be provided.

For example, when the configuration in FIG. 6 will be described, in addition to changing the display area or the information amount to be displayed of the external environment warning information according to the urgency determined by the information urgency state determining unit 11 based on the state of the vehicle acquired by the vehicle state acquiring unit 10, the display area or the information amount to be displayed is changed based on the state of the driver in the case of the low urgency etc., whereby more accurate information can be provided.

In addition, for example, when the configuration in FIG. 7 will be described, in addition to changing the display area or the information amount to be displayed of the external environment warning information according to the urgency determined by the information urgency state determining unit 11 based on the visibility of the driver determined by the visibility state determining unit 16 based on the state outside the vehicle acquired by the vehicle outside state acquiring unit 15 and the state of the vehicle acquired by the vehicle state acquiring unit 10, the display area or the information amount to be displayed is changed based on the state of the driver in the case of the low necessity to consider the state outside the vehicle, and the like, whereby more accurate information can be provided. Moreover, in the case where the vehicle state acquiring unit 10 and the information urgency state determining unit 11 shown in FIG. 7 are not provided therefor, and where in addition to changing the display area or the information amount to be displayed of the external environment warning information according to the visibility of the driver determined by the visibility state determining unit 16 based on the state outside the vehicle acquired by the vehicle outside state acquiring unit 15, the necessity to consider the state outside the vehicle is low, and the like, the display area or the information amount to be displayed may be changed based on the state of the driver. Also in this case, there is an advantageous effect such that more accurate information can be provided.

As described above, according to Embodiment 10, necessary information can be displayed in an appropriate display area that is readily viewable according to the state of the driver in addition to the state of the vehicle and the state outside the vehicle. Consequently, the driver can acquire the necessary information more accurately while driving.

### Embodiment 11

In Embodiment 10, the embodiment in which the driver state acquiring unit 17 acquires the height of the line of sight of the driver as the information related to the state of the driver has been described. In present Embodiment 11, an embodiment in which the driver state acquiring unit 17 acquires the age of the driver as the information related to the state of the driver will be described.

Since a configuration of a vehicle-mounted display control device 1 according to Embodiment 11 of the present invention is similar to the configuration of the vehicle-mounted display control device 1 described in Embodiment 10 with reference to FIGS. 6 and 7, a redundant description will be omitted.

Since the operation of the vehicle-mounted display control device 1 according to Embodiment 11 of the present invention only differ from the operation described in Embodiment 10 with reference to FIG. 8 in contents of steps ST302 to ST304, only the different contents will be described.

In step ST302 shown in FIG. 8, in present Embodiment 10, the driver state acquiring unit 17 acquires the age of the driver as the information on the state of the driver. As a method of acquiring the age of the driver, a conventional method has only to be used. Specifically, for example, the following has only to be performed: a photograph of the driver is taken by a camera installed in the vehicle, and the age of the driver is acquired by authentication of the photographed image. Alternatively, at the time the driver sits on a driver's seat, his/her age is inputted through an input unit (not depicted) equipped in the vehicle-mounted display control device 1, and the driver state acquiring unit 17 receives the inputted age information from the input unit, so that the age may be acquired. Note that these are merely examples and the age of the driver may be acquired using any other methods.

The driver state determining unit 18 receives the age acquired by the driver state acquiring unit 17 in step ST302 and determines a driver attribute or, in other words, a state (age group) of the driver based on the received age (ST303). Specifically, based on the age acquired from the driver state acquiring unit 17, a person of 65 years of age or more

is determined to be an “elderly person” and a person of 64 years of age or less is determined to be a “young person.” Moreover, while the person of 65 years of age or more is determined to be the “elderly person” and the person of 64 years of age or less is determined to be the “young person” in this case, this is not restrictive and the age determined to be the elderly person can be set as appropriate.

The display mode deciding unit 12 collates the age of the driver determined by the driver state determining unit 18 in step ST303 with a determination rule and performs control of the display unit 13 (step ST304). Additionally, the control mentioned here refers to deciding a display area and increasing or reducing an information amount with respect to the information to be displayed. Specifically, reference to the control parameter 14 is made and an appropriate display area and an appropriate information amount to be displayed are decided. For example, when the driver is the “elderly person”, the instrument panel area, the navigation area, and the on-dashboard area are assumed to be the appropriate display areas. When the driver is the “young person”, the HUD display area is assumed to be the appropriate display area. These corresponding display areas are registered in the control parameter in advance.

Moreover, only the display area may be changed based on the state of the driver as described above or only the information amount to be displayed may be changed. Alternatively, both the display area and the information amount to be displayed may be changed.

As described above, according to Embodiment 11, necessary information can be displayed in the appropriate display area that is readily viewable in accordance with the state of the driver in addition to the state of the vehicle and the state outside the vehicle in a similar manner to Embodiment 10. Consequently, the driver can acquire the necessary information more accurately while driving.

### Embodiment 12

In present Embodiment 12, as yet another embodiment, an embodiment in which the driver state acquiring unit 17 acquires visual aid information of the driver as the information related to the state of the driver will be described.

Since a configuration of a vehicle-mounted display control device 1 according to Embodiment 12 of the present invention is similar to the configuration of the vehicle-mounted display control device 1 described in Embodiments 10 and 11 with reference to FIGS. 6 and 7, a redundant description will be omitted.

Since the operation of the vehicle-mounted display control device 1 according to Embodiment 12 of the present invention only differ from the operation described in Embodiments 10 and 11 with reference to FIG. 8 in contents of steps ST302 to ST304, only the different contents will be described.

In step ST302 shown in FIG. 8, in present Embodiment 12, the driver state acquiring unit 17 acquires the visual aid information of the driver or, in other words, visual aid usage information of the driver as the information on the state of the driver.

The driver state determining unit 18 receives the visual aid information acquired by the driver state acquiring unit 17 in step ST302 and determines a driver attribute or, in other words, the state of the driver based on the received visual aid information (ST303). Specifically, the following has only to be conducted: at the time the driver sits on a driver's seat, the visual aid information to be used, such as lenses, is inputted through an input unit (not depicted) equipped in the vehicle-mounted display control device 1, and the driver state acquiring unit 17 receives the inputted visual aid information from the input unit, whereby it is determined whether or not the driver is using the visual aid. Moreover, this is merely an example and the visual aid information of the driver may be calculated using any other methods.

The driver state acquiring unit 17 normally determines that the state of the driver is “naked eyes”, and based on the received visual aid information of the driver, determines whether or not the driver is “using a multifocal lens (far- and near-sighted lens)”, whether or not the driver is “using a multifocal lens (medium- and near-sighted lens)”, whether or not the driver is “using an asthenopia-relieving progressive lens”, and whether or not the driver is “using a lens for near-sightedness”. In the cases of the multifocal lens (far- and near-viewing lens) and the multifocal lens (medium- and near-viewing lens), ranges of a far-viewing (medium-viewing lens) and a near-viewing lens are respectively specified. For example, information such as an alternative vision type far- and near-viewing lens in which an upper part of the lens is used for far viewing and a lower part of the lens is used for near viewing is obtained. Note that the lens mentioned here refers to all visual aids using a lens such as a contact lens and eyeglass lens.

The display mode deciding unit 12 collates the visual aid information of the driver determined in step ST303 with a determination rule and performs control of the display unit 13 (step ST304). Additionally, the control mentioned here refers to deciding a display area and increasing or reducing an information amount with respect to the information to be displayed. Specifically, reference to the control parameter 14 is made and an appropriate display area and an appropriate information amount to be displayed are decided. For example, when the driver is “using the multifocal lens (far- and near-viewing lens)”, the HUD upper area, the navigation area, and the on-dashboard area are assumed to be the appropriate display areas, when the driver has “naked eyes”, the HUD area and the on-dashboard area are assumed to be the appropriate display areas, when the driver is “using the asthenopia-relieving progressive lens”, the navigation area, the instrument panel area, and the on-dashboard area are assumed to be the appropriate display areas, and when the driver is “using the multifocal lens (medium- and near-viewing lens)”, the HUD lower area, the instrument panel area, and the on-dashboard area are assumed to be appropriate display areas. These corresponding display areas are registered in the control parameter in advance.

Moreover, only the display area may be changed based on the state of the driver as described above or only the information amount to be displayed may be changed. Alternatively, both the display area and the information amount to be displayed may be changed.

As described above, according to Embodiment 12, necessary information can be displayed in the appropriate display area that is readily viewable in accordance with the state of the driver in addition to the state of the vehicle and the state outside the vehicle in a similar manner to Embodiments 10 and 11. Consequently, the driver can acquire the necessary information more accurately while driving.

### Embodiment 13

In present Embodiment 13, as yet another embodiment, an embodiment in which the driver state acquiring unit 17 acquires an eyeball movement amount of a driver as the information related to the state of the driver will be described.

Since a configuration of a vehicle-mounted display control device 1 according to Embodiment 13 of the present invention is similar to the configuration of the vehicle-mounted display control device 1 described in Embodiments 10 to 12 with reference to FIGS. 6 and 7, a redundant description will be omitted.

Since the operation of the vehicle-mounted display control device 1 according to Embodiment 13 of the present invention only differ from the operation described in Embodiments 10 to 12 with reference to FIG. 8 in contents of steps ST302 to ST304, only the different contents will be described.

In step ST302 shown in FIG. 8, in present Embodiment 13, the driver state acquiring unit 17 acquires the eyeball movement amount of the driver as the information on the state of the driver. Specifically, the eyeball movement amount of the driver is calculated based on an image of the driver photographed by an imaging camera installed in front of the driver. In this case, an eyeball position when the driver sits on a driver's seat is operated as an initial value. Moreover, this is merely an example and the eyeball movement amount of the driver may be calculated using any other methods.

The driver state determining unit 18 receives the eyeball movement amount acquired by the driver state acquiring unit 17 in step ST302 and determines a driver attribute or, in other words, the state of the driver based on the received eyeball movement amount (ST303). Specifically, for example, when a displacement of 4 cm or more of a position of the eyeball of the driver on a two-dimensional planar video occurs five times or more per minute, a determination is made that a burden of information acquisition is “high”, and a determination that the burden of information acquisition is “low” is made in the other cases. Additionally, while a determination is made that the burden of information acquisition is “high” when the displacement of 4 cm or more of the position of the eyeball of the driver on the two-dimensional planar video occurs five times or more per minute in this case, this is not restrictive and a criterion of determination of whether or not the burden of information acquisition is high can be set as appropriate.

The display mode deciding unit 12 collates the burden of information acquisition of the driver determined in step ST303 with a determination rule and performs control of the display unit 13 (step ST304). Additionally, the control mentioned here refers to deciding a display area and increasing or reducing an information amount with respect to the information to be displayed. Specifically, reference to the control parameter 14 is made and an appropriate display area and an appropriate information amount to be displayed are decided. For example, when the burden of information acquisition of the driver is “high”, display at the HUD display areas or the on-dashboard area is increased or display at the instrument panel area or the navigation area is reduced. These corresponding display areas are registered in the control parameter in advance.

Additionally, only the information amount to be displayed may be changed based on the state of the driver as described above or only the display area may be changed. Alternatively, both the display area and the information amount to be displayed may be changed.

As described above, according to Embodiment 13, necessary information can be displayed in an appropriate display area that is readily viewable in accordance with the state of the driver in addition to the state of the vehicle and the state outside the vehicle in a similar manner to Embodiments 10 to 12. Consequently, the driver can acquire the necessary information more accurately while driving.

### Embodiment 14

In present Embodiment 14, as yet another embodiment, an embodiment in which the driver state acquiring unit 17 acquires an eyeball position of a driver as the information related to the state of the driver will be described.

Since a configuration of a vehicle-mounted display control device 1 according to Embodiment 14 of the present invention is similar to the configuration of the vehicle-mounted display control device 1 described in Embodiments 10 to 13 with reference to FIGS. 6 and 7, a redundant description will be omitted.

Since the operation of the vehicle-mounted display control device 1 according to Embodiment 14 of the present invention only differ from the operation described in Embodiments 10 to 13 with reference to FIG. 8 in contents of steps ST302 to ST304, only the different contents will be described.

In step ST302 shown in FIG. 8, in present Embodiment 14, the driver state acquiring unit 17 acquires the eyeball position of the driver as the information on the state of the driver and calculates a gaze location and a gaze time. As a method of acquiring the eyeball position, conventional techniques have only to be used. For example, the eyeball position has only to be acquired based on an image of the driver photographed by an imaging camera installed in front of the driver's seat. An eyeball position when the driver sits on the driver's seat is operated as an initial value, and the gaze location is calculated based on a distance of movement of the eyeball position from the initial eyeball position or a time for which the eyeball position is fixed to each gaze location is measured. Additionally, while the eyeball position of the driver is acquired based on the image of the driver photographed by the imaging camera, this is not restrictive and the eyeball position may be acquired by another method.

The driver state determining unit 18 receives the information on the gaze location and gaze time of the driver calculated by the driver state acquiring unit 17 in step ST302, and determines a driver attribute or, in other words, the state of the driver based on the received information on the gaze location and the gaze time of the driver (step ST303). Specifically, the driver state determining unit 18 determines whether a line-of-sight gaze amount of the driver is “high” or “low” at each display area. For example, when the line of sight stops at one display area for 2 seconds or more, the driver state determining unit 18 determines that the gaze amount of the display area is “high”, and in other cases, determines that the gaze amount is “low”. In this case, the display areas refer to the seven display areas shown in FIG. 3.

In addition, while a determination that the gaze amount is “high” is made when the line of sight stops at one display area for 2 seconds or more, this is not restrictive and a criterion for determining that the gaze amount is “high” can be set as appropriate.

The display mode deciding unit 12 collates the visibility state determined in step ST303 with a determination rule and performs control of the display unit 13 (step ST304). Additionally, the control mentioned here refers to increasing or reducing an information amount in a display area with respect to the information to be displayed. Specifically, reference to the control parameter 14 is made and an appropriate display area and an appropriate information amount to be displayed are decided. For example, with respect to the display area whose gaze amount is determined to be “high”, the information amount of the area is reduced or display in the area is eliminated. These corresponding information amounts of the display areas are registered in the control parameter in advance.

Moreover, only the information amount to be displayed may be changed based on the state of the driver as described above or only the display area may be changed. Alternatively, both the display area and the information amount to be displayed may be changed.

As described above, according to Embodiment 14, necessary information can be displayed in the appropriate display area that is readily viewable in accordance with the state of the driver in addition to the state of the vehicle and the state outside the vehicle in a similar manner to Embodiments 10 to 13. Consequently, the driver can acquire the necessary information more accurately while driving.

Moreover, a configuration that appropriately combines Embodiments 1 to 14 can be adopted so as to include any one of the information urgency state determining unit 11, the visibility state determining unit 16, and the driver state determining unit 18. In this case, the display mode deciding unit 12 can change the area at which the information is to be displayed or the information amount to be displayed based on the result of determination by any one of the information urgency state determining unit 11, the visibility state determining unit 16, and the driver state determining unit 18.

It is to be understood that the respective embodiments of the present invention may be combined in any way and any component of the respective embodiments of the present invention may be modified or omitted without departing from the spirit and scope of the invention.

### INDUSTRIAL APPLICABILITY

The vehicle-mounted display control device of the present invention, with respect to the information to be displayed by the vehicle, changes the information to be displayed or the information amount to be displayed according to the state of the vehicle, to thereby enhance visibility of the display and prevent inhibition for driving by visually confirming the display, and thus, it is applicable to a vehicle-mounted display control device or the like that provides a driver with information during traveling.

### DESCRIPTION OF REFERENCE NUMERALS AND SIGNS

1: Vehicle-mounted display control device
10: Vehicle state acquiring unit
11: Information urgency state determining unit
12: Display mode deciding unit
13: Display unit
14: Control parameter
15: Vehicle outside state acquiring unit
16: Visibility state determining unit
17: Driver state acquiring unit
18: Driver state determining unit

1-13. (canceled)

14. A vehicle-mounted display control device that provides a driver with information during traveling, said device comprising:
a vehicle state acquirer that acquires information related to a state of a vehicle as the information to be provided to the driver;
an urgency determiner that determines urgency of the information acquired by the vehicle state acquirer;
a driver state acquirer that acquires information related to one of a height of a line of sight, an age, and a visual aid of the driver; and
a display mode decider that decides as a display mode a display area that displays the information provided during traveling and a display information amount in the display area, based on a result of determination by the urgency determiner, and the information related to one of the height of the line of sight, the age, and the visual aid of the driver.

15. The vehicle-mounted display control device according to claim 14, further comprising:
a vehicle outside state acquirer that acquires information related to a state outside the vehicle; and
a visibility state determiner that determines a visibility state of the driver based on the information acquired by the vehicle outside state acquirer, wherein
the display mode deciding unit decides the display mode based on the result of determination by the urgency determining unit, one of the height of the line of sight, the age, and the visual aid of the driver, and a result of determination by the visibility state determiner.

16. The vehicle-mounted display control device according to claim 14, wherein
the vehicle state acquirer acquires a legal speed limit at a current location and a speed of the host vehicle, and
the urgency determiner determines the urgency of the information based on the legal speed limit at the current location and the speed of the host vehicle.

17. The vehicle-mounted display control device according to claim 14, wherein
the vehicle state acquirer acquires a distance between a destination and a current location or a time required to reach the destination, and
the urgency determiner determines the urgency of the information based on the distance between the destination and the current location or the time required to reach the destination.

18. The vehicle-mounted display control device according to claim 14, wherein
the vehicle state acquirer acquires environment information inside the vehicle, and
the urgency determiner determines the urgency of the information based on the environment information and a reference value set in advance.

19. The vehicle-mounted display control device according to claim 14, wherein
the vehicle state acquirer acquires a vehicle front state or a vehicle rear state, and
the urgency determiner determines the urgency of the information based on presence or absence of a vehicle front or vehicle rear attention object.

20. The vehicle-mounted display control device according to claim 15, wherein
the vehicle outside state acquirer acquires illuminance outside the vehicle, and
the display mode decider decides the display mode when the illuminance is equal to or higher than a reference level set in advance.

21. The vehicle-mounted display control device according to claim 15, wherein
the vehicle outside state acquirer acquires presence or absence of a display obstacle outside the vehicle, and
the display mode decider does not display the information in a display area with a background in which the display obstacle is present.

22. The vehicle-mounted display control device according to claim 15, wherein
the vehicle outside state acquirer acquires current location peripheral facility information, and
the display mode decider decides the display mode based on the current location peripheral facility information.
